(19) United States
(12) Patent Application Publication
(10) Pub. No.: US 2013/0310487 A1
(43) Pub. Date: Nov. 21, 2013

(54) Thermally Conductive, Electrically Insulating, Silicon-Containing Epoxy Molding Compounds

(71) Applicant: Mossey Creek Solar, LLC, Jefferson City, TN (US)

(72) Inventors: John Carberry, Talbott, TN (US); Andrew A. Wereszczak, Oak Ridge, TN (US)

(73) Assignee: Mossey Creek Solar, LLC, Jefferson City, TN (US)

(21) Appl. No.: 13/667,655

(22) Filed: Nov. 2, 2012

Related U.S. Application Data
(60) Provisional application No. 61/554,764, filed on Nov. 2, 2011.

(51) Int. Cl. C08K 3/34

(52) U.S. Cl. CPC C08K 3/34
USPC 523/466

(57) ABSTRACT

Thermally conductive, electrically insulating epoxy molding compounds that use milled silicon as a filler material, and methods and processes for making the same. Some example embodiments of the present invention comprise the use of a passivation agent, for example ethyl silicate, to deposit a thin layer of glass on the surfaces of the powders as the powders are milled, creating an attractive surface dielectric property on these surfaces.

### CROSS-REFERENCE TO RELATED APPLICATIONS

This application claims the benefit under 35 U.S.C. section 119(e) of U.S. Provisional Patent Application No. 61/554,764, filed Nov. 2, 2011.

### STATEMENT REGARDING FEDERALLY SPONSORED RESEARCH OR DEVELOPMENT

This invention was made with government support under DE-AC05-000R22725 awarded by the U.S. Department of Energy. The government has certain rights in the invention.

### BACKGROUND OF THE INVENTION

1. Field of Invention

The present general inventive concept relates to the preparation and use of epoxy molding compounds and in particular to the preparation and use of thermally conductive, electrically insulating epoxy molding compounds that include milled silicon as a filler material.

2. Description of the Related Art

A number of applications for encapsulating semiconductor devices, inverters, film capacitors, motor elements and the like with epoxy molding compounds (EMC) are bringing a greater emphasis on the need for high thermal conductivity, which must by definition be contributed by the EMC filler. These include power semiconductors, semiconductors for ignition modules, LED lighting applications, inverters, capacitors and applications where device density also emphasizes the need for thermal management through higher thermal conductivity.

The typical materials generally used in designing and making encapsulating compounds for semiconductor devices are plastic molding compounds which typically have a low dielectric. These plastic molding compounds, which are composite materials, normally include epoxy resins, phenolic hardeners, mineral fillers, catalysts, pigments, and mold release agents.

Several important properties of the filler include the coefficient of thermal expansion (CTE), thermal conductivity, morphology, particle size, particle size distribution, effect of the filler on spiral flow and viscosity, electrical properties, and cost.

Traditionally, 40 years ago, typical mineral fillers included milled silica, quartz, and glass. During the past 25 years fused silica and fumed filler became dominant as they brought a low CTE and could be combined in particle size distribution that favored low viscosity flow at temperature, good spiral flow and high solids loading, as high as 80% or more. The key drawback of fused silica is the low thermal conductivity.

There exists a need to find a material for use as a filler having a high thermal conductivity. In particular they teach the needs to fulfill the priorities of thermal dissipation, control over thermal expansion, a low dielectric constant and low costs.

### BRIEF SUMMARY OF THE INVENTION

The present invention, in some of its several embodiments, comprises the use of milled silicon as a filler material in a thermally conductive, electrically insulating epoxy molding compound. In some embodiments, the epoxy molding compound includes silicon milled according to a process taught by U.S. Pat. No. 6,638,491.

Some example embodiments of the present invention comprise the use of a passivation agent, for example ethyl silicate, to deposit a thin layer of glass on the surfaces of the powders as the powders are milled, creating an attractive surface dielectric property on these surfaces. Some example embodiments of the present invention comprise the use of a form of the epoxy itself to passivate the surface of the powders. Additionally, some example embodiments of the present invention comprise passivating the surfaces of the semiconductor structures themselves before submitting to epoxy molding compound.

In one example embodiment of the present invention, a process for fabricating a thermally conductive, electrically insulating epoxy molding compound comprises combining an initial feedstock of silicon metal particulates with an extracting liquid into a mixture and milling said mixture. At least a portion of the milled mixture is withdrawn, and the milled silicon metal particulates are separated from the extracting liquid. The milled silicon metal particulates are then mixed with a resin to form an epoxy molding compound.

In another example embodiment of the present invention, a method for fabricating a thermally conductive, electrically insulating epoxy molding compound comprises admixing a first quantity of silicon metal particulates with a liquid having the ability to extract one or more oxidants from the silicon metal particulates. The admixing is maintained for a time sufficient for wetting the first quantity of silicon metal particulates in the liquid prior to attrition to develop a mixture of liquid and oxidant-free particulates. The mixture of particulates and liquid are introduced into an attrition mill in the absence of oxidants; the mixed components are subjected to attrition in the attrition mill for a time sufficient to reduce at least a portion of said silicon metal particulates to a preselected average particle size and for said liquid to extract one or more oxidants from said silicon metal particulates to produce a second quantity of reduced particle size silicon metal particulates being essentially oxidant free. Withdrawing from the attrition mill at least a portion of said second quantity of reduced particle size silicon metal particulates, along with a portion of the extracting liquid, the milled silicon metal particulates are mixed with a resin to form an epoxy molding compound that is thermally conductive and electrically insulating.

### BRIEF DESCRIPTION OF THE SEVERAL VIEWS OF THE DRAWINGS

The above-mentioned features and other aspects of the invention will become more clearly understood from the following detailed description of the invention read together with the drawings in which:

FIG. 1 is a flow diagram of an example embodiment of a process for fabricating a thermally conductive, electrically insulating epoxy molding compound; and

FIG. 2 is a flow diagram of an example embodiment of a method for fabricating a thermally conductive, electrically insulating epoxy molding compound.

### DETAILED DESCRIPTION OF THE INVENTION

Disclosed herein are materials, methods and processes that comprise the use of milled silicon as a filler material in thermally conductive, electrically insulating epoxy molding compounds. In some embodiments, the epoxy molding compound includes silicon milled according to a process taught by U.S. Pat. No. 6,638,491.

Thermally conductive, electrically insulating epoxy molding compounds have current or potential uses in many applications, many of which can have a critical impact on the global human carbon dioxide footprint. For example:

(1) LED lighting is limited mostly and uniquely by the requirements for thermal management. LEDs are semiconductor devices and their spectrum, lifetime and operating parameters are largely driven by operating temperatures at the junction which can only be controlled and optimized by the heat sink and the EMC. This is a very worthwhile endeavor as a long life broad spectrum LED could reduce energy for lighting world wide from the current 1.2 TWh a year by as much as 95%.

(2) BeO is still used in some power semiconductor applications, notably, the power ignition module. There is a strong desire to eliminate BeO because of its toxicity, cost and high CTE.

(3) Making all semiconductors more efficiently with respect to thermal management will extend life time, reduce energy required, and increase performance, all in ways that can dramatically reduce cost energy and the world's carbon footprint.

(4) Inverters and film capacitors used in many applications, notably hybrid automobiles for instance, require very high thermal conductivity to optimize performance and weight to power ratios.

The following tables provide some information about the candidates:

TABLE 1
Material Resistivity

| Material | Resistivity [Ω · m] at 20° C. |
|---|---|
| Silver | 1.59 × 10⁻⁸ |
| Copper | 1.68 × 10⁻⁸ |
| Gold | 2.44 × 10⁻⁸ |
| Aluminium | 2.82 × 10⁻⁸ |
| Silicon^{[10]} | 6.40 × 10² |
| Glass | 10¹⁰ to 10¹⁴ |
| Hard rubber | approx. 10¹³ |
| Sulfur | 10¹⁵ |
| Paraffin | 10¹⁷ |
| Quartz (fused) | 7.5 × 10¹⁷ |
| PET | 10²⁰ |
| Teflon | 10²² to 10²⁴ |

TABLE 2
Filler Candidates

| | Thermal | Specific | Est Cost |
|---|---|---|---|
| W/M*k | Conductivity | Gravity | USD/kg |
| Silicon | 149 | 2.329 | 10 |
| Silica | 1.38 | 2.634 | 2 |
| Alumina | 18 | 3.99 | 5 |
| Beryllia | 330 | 3.02 | 800 |
| Aluminum | | | |
| Nitride | 280 | 3.26 | 400 |
| SiC | 4 | 3.2 | 40 |

TABLE 3
Substrate Candidates which might be milled into powder for fillers

| | | | Thermal | Thermal | | |
|---|---|---|---|---|---|---|
| | Specific | | Conductivity | Conductivity | Specific | |
| | Gravity | CTE | w/M*K | w/M*K | Heat | Resistivity |
| Material | grams/cc | PPM | Theoretical | As made | J/KG*K | Ohm/cm |
| BeO | 3.02 | 8 | 330 | 265 | 1925 | 10 15 |
| AlN | 3.26 | 4.5 | 320 | 140-180 | 740 | 10 14 |
| Al2O3 | 3.99 | 8.1 | 30 | 18 | 880 | 10 14 |

From the foregoing, the following is evident:

Al₂O₃ while being inexpensive and a low dielectric, has a high CTE and a low thermal conductivity;

BeO has a high thermal conductivity, low dielectric, but is toxic and expensive and has a high CTE;

AN has a low dielectric, and high thermal conductivity and a low CTE, but is expensive;

Glass, including fused silica, is inexpensive, has a low dielectric, a low CTE but a very low thermal conductivity, but is still favored, because of low cost and low CTE and low dielectric;

To date, silicon has not been used, possibly for two key reasons: first, that milled silicon has till today not been available because of the danger of milling silicon to sizes in the micron range; and second, that unless it is pure it may be too electrically conductive to use as a filler for EMC bodies.

Therefore as an example we propose the use of silicon milled according to a method disclosed in U.S. Pat. No. 6,638,491, issued to Carberry. In such a case the use of this technology is helpful in that it provides for a safe cost effective way to mill silicon. Furthermore, double milling trials, using two different size milling media in sequence have provided very attractive tri and bi modal particle size distributions helpful in achieving high solids loading in epoxy, as demonstrated by the attached PDF serial number S3354.

In one example embodiment of a method according to the present invention, an initial feedstock of silicon metal particulates is admixed with a liquid that is suitable for the extraction of oxidants such as water, oxygen, hydroxyl radicals, and the like, from silicon metal particulates. In one example embodiment, the liquid oxidant extractant employed suitably is ethanol. Other liquids or combinations of liquids which are essentially inert to silicon and which are capable of extracting oxidants from silicon particulates are employed in other embodiments. Generally the liquid oxidant extractant is readily distilled for purposes of separating oxidants from the liquid so that the liquid oxidant extractant may be recycled. Examples of such other liquids include a number of dry alcohols.

The quantity of liquid initially admixed with the silicon particulates is not particularly critical so long as the quantity of liquid added is sufficient to fully wet the silicon particulates and have the capacity to attract and extract oxidants from the surfaces of silicon particulates. One suitable ratio of silicon metal particulates to the liquid is approximately 1:1 by volume. The admixing function need only be carried out for a time sufficient to ensure good distribution of the silicon particulates in the liquid. Normally, stirring of this mixture is not required, but may be employed as needed.

The mixture so formed is introduced into an attrition mill wherein the size of each of the first quantity of silicon metal particulates being greater than about 100 microns, is reduced toward a preselected relatively smaller average particle size, producing a second quantity having an average particle size of about 12 microns or smaller. Generally, the size of each of the second quantity of silicon metal particulates is at least one micron in diameter; smaller particulate diameters can reduce the thermal conductivity of the silicon, as shown by Wang et al. (J. Appl. Physics 110, 024312[2011]). The transfer of the mixture of silicon metal particulates and liquid from a vessel to the attrition mill preferably is direct and in the absence of oxidants from an external source. The retention time of the mixture within the attrition mill is dependent upon several factors, such as the initial average particle size of the silicon metal particulates, the speed of operation of the attrition mill, and the preselected final average particle size of the silicon metal particulates. The addition of ceramic pellets (zirconia pellets, for instance) to the attrition mill has been found useful in accelerating the milling of the silicon metal particulates.

The second quantity of reduced sized particulates, along with a portion of the liquid oxidant extractant, are withdrawn from the bottom end of the attrition mill. Optionally, the withdrawn portion of liquid and reduced sized particulates may be recovered for use in certain chemical applications wherein the presence of the liquid is non-detrimental or possibly of value. Commonly, however the withdrawn portion of liquid and reduced sized particulates is conveyed to a drying station wherein the particulates are cooled and the liquid oxidant extractant is extracted from the mixture, all under a cover of inert gas, such as argon. The cooled and dried and essentially oxidantfree reduced-size particulates are recovered for use in a subsequent chemical application. This withdrawal and transfer of the desired final average particle size silicon metal particulates, along with a portion of the liquid from the attrition mill to the drying station may be direct and in the absence of oxidants from an external source.

Withdrawal of a portion of the liquid and reduced-size silicon metal particulates from the mill may be through a screen located in the bottom end of the mill. Such screen may be chosen to permit the passage therethrough of only those silicon metal particulates of a given or small particle size, thereby limiting the withdrawal to such sized particulates (along with some liquid). Optionally, a portion of the mixture within the mill may be withdrawn and passed through an external screening operation wherein the desired particle size particulates are extracted, along with liquid. In either event, those particulates which require further size reduction may be recycled by a conduit to the top end of the mill or, in some instances, merely held within the mill for further processing.

Within the drying station, while maintained under an atmosphere of inert gas, such as argon, the reduced-size particulates are cooled and the liquid is extracted from the particulates. This extracted liquid contains both the original liquid and any water, oxygen, or other oxidants which have been extracted from the silicon metal particulates in the course of the admixing and milling functions. This extracted liquid, in one embodiment, may be advantageously treated, as by distillation techniques, to remove the captured oxidants from the original liquid, e.g. ethanol, which is desirable by reason of its ease of distillation, and the original liquid so recovered is recycled by a transfer process known to those skilled in the art to the admixing function of the present method.

The extraction in the drying station of the liquid from the mixture of the liquid and reduced size silicon metal particulates serves to cool and dry the particulates, therefore separating from the particulates the liquid and its captured oxidants and rendering the reduced size silicon metal particulates free of oxidants.

The cooled, dried, and oxidant-free silicon metal particulates, still held under an atmosphere of inert gas, may be packaged into individual containers or bulk packages for subsequent use in various known chemical applications.

In the course of the milling operation of the present method, it has been found to be advantageous at times to withdraw a portion of the mixture of incompletely size-reduced particulates from the bottom end of the attrition mill and return the same to the top end of the mill for recycling thereof.

Any excess hydrogen generated in the course of the milling operation will be drawn off by ethanol, and/or may be vented and flared. This process, if it occurs, is advantageous for the reason that any free oxygen or water within the mill will react with the hydrogen gas stream, thereby further serving to dry the environment within the mill.

The advantages of the silicon include the very high thermal conductivity, the low CTE, relatively low cost. Thermal Conductivity at 145 W/M*k, in the ball park of commercially available aluminum nitride, only slightly inferior to commercially available BeO, an order of magnitude better than Al₂O₃, and two orders of magnitude better than fused silica. Silicon's CTE, at 2.8-3.2 ppm, is competitive with other candidates. Only fused silica is lower, at 0.5 ppm. Aluminum nitride is close, at 4.5 ppm. BeO and Al₂O₃ are both much higher at 8 ppm. But at 3 ppm it should, with proper solids loading, be able to modify the epoxy resin, which is 15-100 ppm, to a low value of around 5 ppm, much as fused silica does.

The Fracture Toughness (K1C) of silicon is about 1, which is similar to fused silica. One can expect the same milling fracture behavior, morphology, particle size and particle size distribution as with fused silica.

In addition one can expect the same or superior chemical reaction between the surface of the silicon with silanes used in the process of making epoxy molding compounds as is experienced with silica.

In terms of cost, only fused silica will be less costly than silicon, but silicon will be in the same order of magnitude, while all others are going to be very expensive.

Therefore the remaining challenge is the electrical properties. Given the great benefit silicon offers in all other regards, it is worthy therefore to solve this problem so to enable packaging with much greater thermal dissipation capability.

Some example embodiments of the present invention comprise the use of a passivation agent, for example ethyl silicate, to deposit a thin layer of glass on the surfaces of the powders as the powders are milled, creating an attractive surface dielectric property on these surfaces.

Some example embodiments of the present invention comprise the use of a form of the epoxy itself to passivate the surface of the powders.

Additionally, some example embodiments of the present invention comprise passivating the surfaces of the semiconductor structures themselves before submitting to epoxy molding compound.

Current epoxy molding compounds are filled with quartz or fused silica having a thermal conductivity of about 1.45 watts, and are filled by volume to about 50% filler, 50% resin. The thermal conductivity of the resin is about 0.3 watts, so that the resulting epoxy molding compounds have thermal conductivity of about 0.7-0.9 watts. Silicon has nearly ideal properties with regard to the CTE (about 3 ppm) and thermal conductivity (about 150 watts) and cost, and should allow us to make epoxy molding compounds with an order of magnitude or more increase in thermal conductivity.

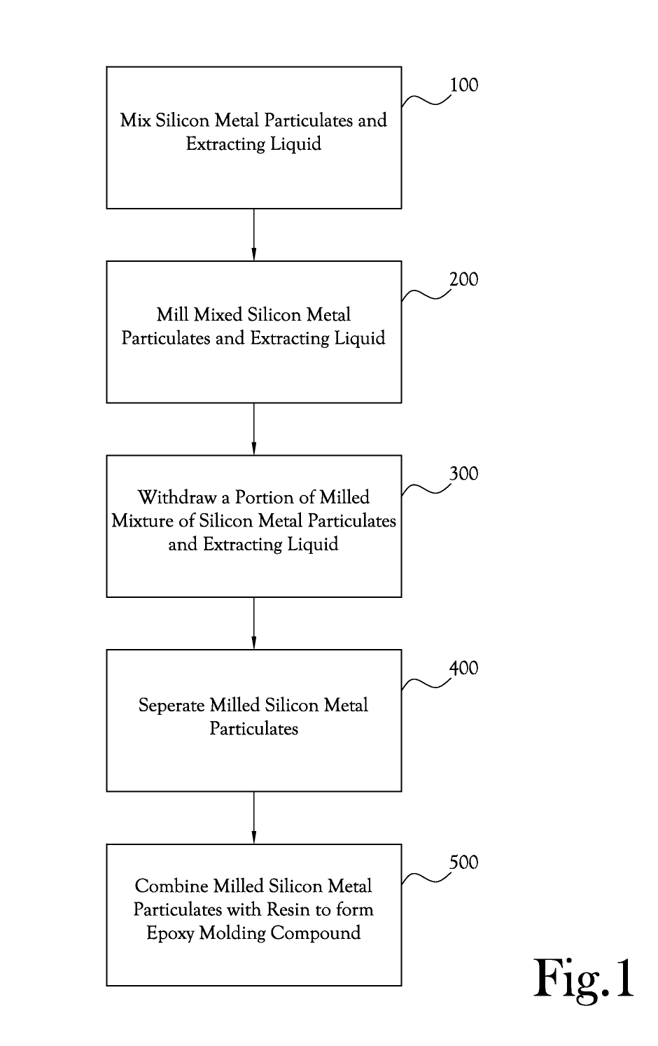

In one example embodiment of the present invention, illustrated generally by the flow diagram in FIG. 1, a process for fabricating a thermally conductive, electrically insulating epoxy molding compound comprises combining 100 an initial feedstock of silicon metal particulates with an extracting liquid into a mixture and milling said mixture 200. At least a portion of the milled mixture is withdrawn 300, and the milled silicon metal particulates are separated from the extracting liquid 400. The milled silicon metal particulates are then combined with a resin to form an epoxy molding compound 500.

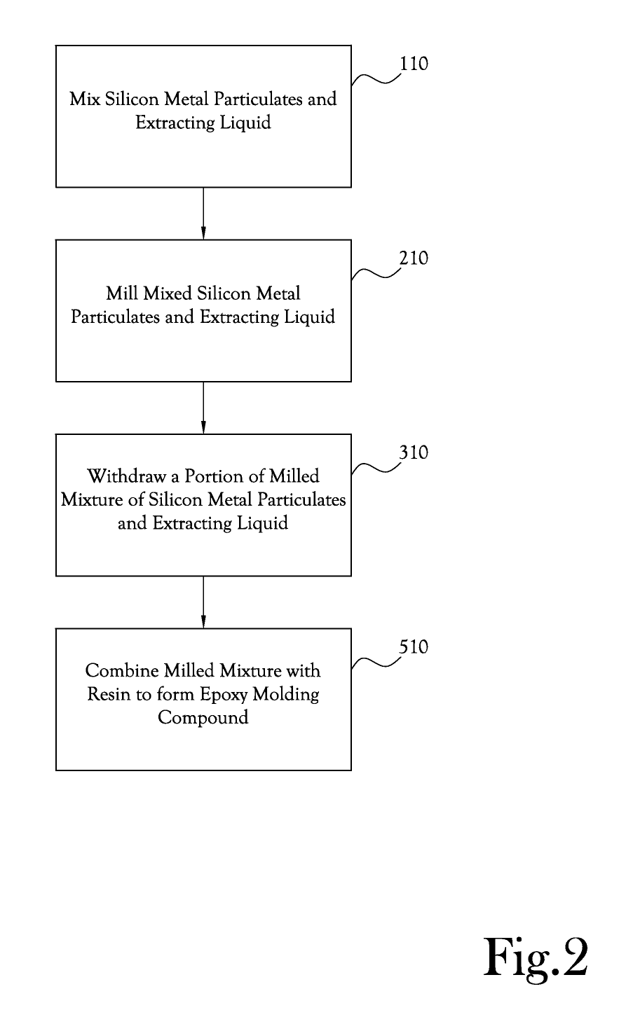

In another example embodiment of the present invention, illustrated generally by the flow diagram in FIG. 2, a method for fabricating a thermally conductive, electrically insulating epoxy molding compound comprises admixing 110 a first quantity of silicon metal particulates with a liquid having the ability to extract one or more oxidants from the silicon metal particulates. The admixing is maintained for a time sufficient for wetting the first quantity of silicon metal particulates in the liquid prior to attrition to develop a mixture of liquid and oxidant-free particulates. The mixture of particulates and liquid are introduced into an attrition mill in the absence of oxidants; the mixed components are subjected to attrition in the attrition mill 210 for a time sufficient to reduce at least a portion of said silicon metal particulates to a preselected average particle size and for said liquid to extract one or more oxidants from said silicon metal particulates to produce a second quantity of reduced particle size silicon metal particulates being essentially oxidant free. Withdrawing from the attrition mill at least a portion of said second quantity of reduced particle size silicon metal particulates 310, along with a portion of the extracting liquid, the milled silicon metal particulates are combined with a resin 510 to form an epoxy molding compound that is thermally conductive and electrically insulating.

In some of the several example embodiments of the current general inventive concept,

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A process for fabricating a thermally conductive, electrically insulating epoxy molding compound, comprising:
providing an initial feedstock of silicon metal particulates;
providing an extracting liquid to extract oxidants from the silicon metal particulates;
combining the silicon metal particulates and the extracting liquid into a mixture and milling said mixture;
withdrawing at least a portion of the milled mixture;
within the withdrawn portion of the milled mixture, separating milled silicon metal particulates from the extracting liquid; and
mixing the milled silicon metal particulates with a resin to form an epoxy molding compound.

2. The process of claim 1 wherein the milled silicon metal particulates are mixed with resin in a ratio of substantially 1:1 by volume.

3. The process of claim 1 further comprising, during the mixing of the milled silicon metal particulates with the resin, using a passivation agent to deposit a layer of silicon-containing material on constituent particulates of the epoxy molding compound.

4. The process of claim 3 wherein the passivation agent comprises ethyl silicate.

5. The process of claim 3 wherein the silicon-containing material is glass.

6. The process of claim 1 further comprising, during the milling of the mixture of silicon metal particulates and extracting liquid, using a passivation agent to deposit a layer of silicon-containing material on constituent particulates of the epoxy molding compound.

7. The process of claim 6 wherein the passivation agent comprises ethyl silicate.

8. The process of claim 6 wherein the silicon-containing material is glass.

9. A method for fabricating a thermally conductive, electrically insulating epoxy molding compound comprising:
admixing a first quantity of silicon metal particulates with a liquid having the ability to extract one or more oxidants from the silicon metal particulates, said step of admixing maintained for a time sufficient for wetting the first quantity of silicon metal particulates in the liquid prior to attrition to develop a mixture of liquid and oxidant-free particulates,
introducing said mixture of particulates and liquid into an attrition mill in the absence of oxidants,
subjecting said silicon metal particulates of said mixture to attrition in the attrition mill for a time sufficient to reduce at least a portion of said silicon metal particulates to a preselected average particle size and for said liquid to extract one or more oxidants from said silicon metal particulates to produce a second quantity of reduced particle size silicon metal particulates being essentially oxidant free,
withdrawing from said attrition mill at least a portion of said second quantity of reduced particle size silicon metal particulates, along with a portion of said liquid, and
mixing the milled silicon metal particulates with a resin to form an epoxy molding compound.

10. The method of claim 9 wherein the milled silicon metal particulates are mixed with resin in a ratio of substantially 1:1 by volume.

11. The method of claim 9 further comprising using a passivation agent to deposit a layer of silicon-containing material on constituent particulates of the epoxy molding compound.

12. The method of claim 11 wherein the passivation agent comprises ethyl silicate.

13. The process of claim 11 wherein the silicon-containing material is glass.

14. An epoxy molding compound comprising:
a heterogeneous mixture of silicon metal particulates with a resin, said silicon metal particulates being substantially free of oxidants,
said heterogeneous mixture of silicon metal particulates with a resin having been formed into a thermally conductive, electrically insulating epoxy molding compound.

15. The epoxy molding compound of claim 14 wherein the silicon metal particulates are mixed with resin in a ratio of substantially 1:1 by volume.

16. The epoxy molding compound of claim 14 wherein constituent particulates of the epoxy molding compound are covered with a layer of silicon-containing material.

17. The epoxy molding compound of claim 14 wherein the silicon-containing material is glass.
